(19) United States
(12) Patent Application Publication
(10) Pub. No.: US 2003/0037030 A1
(43) Pub. Date: Feb. 20, 2003

(54) Method and system for storage, retrieval and execution of legacy software

(75) Inventors: Rabindranath Dutta, Austin, TX (US); Dwip N. Banerjee, Austin, TX (US)

Correspondence Address: Darcell Walker, 8107 Carvel Lane, Houston, TX, 77036, US

(73) Assignee: INTERNATIONAL BUSINESS MACHINES CORPORATION, ARMONK, NY (US)

(21) Appl. No.: 09/931,296

(22) Filed: Aug. 16, 2001

(51) Int. Cl. G06F 7/00

(52) U.S. Cl. 707/1

(57) ABSTRACT

The present invention provides a method and system for creating a software facility that charts the history and development of software programs. This facility would a location on a global computing network that would contain a database storing and maintaining a collection of software programs that span time from the introduction of computers and software beginning in the 1950's to the explosion of various software products being developed today. The intent is for each software version to be stored in an executable form to enable the separate execution of any program stored in the database.

### FIELD OF THE INVENTION

This invention relates to a method and system for storing and retrieving software programs and in particular to a method and system for storing, archiving and cataloging software programs that have been developed throughout history and a method and system for accessing, retrieving and executing these stored software programs.

### BACKGROUND OF THE INVENTION

A computer is machine that performs tasks, such as mathematical calculations or electronic communication, under the control of a set of instructions called a program. Programs usually reside within the computer and are retrieved and processed by the computer's electronics. The program results are stored or routed to output devices, such as video display monitors or printers. Through these programs, computers are used to perform a wide variety of activities with reliability, accuracy, and speed. The programs that run the computer are called software. A software program is generally designed to perform a particular type of task—for example, to control the arm of a robot to weld a car's body, to write a letter, to draw a graph, or to direct the general operation of the computer. A computer typically has several types of software programs that reside inside that computer. These types of software can include: the operating system, machine language programs, assembly language programs, high level language programs and even object-oriented programs.

The operating system is the basic software that controls the computer. When a computer is turned on it searches for instructions in its memory. Usually, the first set of these instructions is a special program called the operating system, which is the software that makes the computer work. It prompts the user (or other machines) for input and commands, reports the results of these commands and other operations, stores and manages data, and controls the sequence of the software and hardware actions. When the user requests that a program run, the operating system loads the program in the computer's memory and runs the program. Popular operating systems, such as Microsoft Windows and the Macintosh system (Mac OS), have a graphical user interface (GUI)that is, a display that uses tiny pictures, or icons, to represent various commands. To execute these commands, the user clicks the mouse on the icon or presses a combination of keys on the keyboard.

In addition to operating system programs, a computer contains software in the form of application programs. These programs perform the tasks desired by the user of the computer. These programs perform functions such as creating and editing text documents, spreadsheets and presentations. Other applications programs such as FORTRAN perform mathematical calculations. Still a third set of programs is known as utility programs. These programs perform functions on the computer that assists the user. Some functions of utility programs include creating folders, transferring files, deleting or adding files and merging files.

Whether the programs are system programs, application programs or utility programs, all programs consist of a set of instructions arranged in a specific order. This arrangement is known as an algorithm. This algorithm is represented in the form of a flow chart. In order to create software from an algorithm, a special language is used to create a command level representation of the algorithm. This special language, known as a “Programming language”, contains a series of commands that create software. In general, this language that is encoded such that a computer's hardware more quickly understands the commands or instructions. A program written in this type of language also runs faster.

Computer programs that can be run by a computer's operating system are called executables. An executable program is a sequence of extremely simple instructions known as machine code. These instructions are specific to the individual computer's CPU and associated hardware; for example, Intel Pentium and Power PC microprocessor chips each have different machine languages and require different sets of codes to perform the same task. Machine code instructions are few in number (roughly 20 to 200, depending on the computer and the CPU). Typical instructions are for copying data from a memory location or for adding the contents of two memory locations (usually registers in the CPU). Machine code instructions are binary—that is, sequences of bits (0s and 1s). Because humans do not understand these numbers easily, computer instructions usually are not written in machine code.

Assembly languages use commands that are easier for programmers to understand than are machine-language commands. Each machine language instruction has an equivalent command in assembly language. For example, in assembly language, the statement “MOV A, B” instructs the computer to copy data from one location to another. The same instruction in machine code could be a string of sixteen 0s and 1s. Once an assembly-language program is written, it is converted to a machine-language program by another program called an assembler. Assembly language is fast and powerful because of its correspondence with machine language. It is still difficult to use, however, because assembly-language instructions are a series of abstract codes. In addition, different CPUs use different machine languages and therefore require different assembly languages. Assembly language is sometimes inserted into a high-level language program to carry out specific hardware tasks or to speed up a high-level program.

High-level languages were developed because of the difficulty of programming assembly languages. High-level languages are easier to use than machine and assembly languages because their commands resemble natural human language. In addition, these languages are not CPU-specific. Instead, they contain general commands that work on different CPUs. Like assembly-language instructions, high-level languages also must be translated, but a compiler is used. A compiler turns a high-level program into a CPU-specific machine language. For example, a programmer may write a program in a high-level language such as C and then prepare it for different machines, such as a Cray Y-MP supercomputer or a personal computer, using compilers designed for those machines. This speeds the programmer's task and makes the software more portable to different users and machines.

An obvious conclusion from this discussion is that software development has seen unprecedented progress. Starting from the basic computers of the 1950's to the unprecedented explosion of the Internet, the path of software development is simply astounding. The development of software today often times results in the introduction of new versions of software products that perform essentially the same functions as other versions of the same software every few months. New versions of the same operating system are introduced every two-to-three years.

Although progress and innovation are healthy for any industry, there are some drawbacks to this rapid expansion and development of software. A computer user may have one version of a program for six months before that version becomes old and out-dated. In many instances the software developer/supplier may not support the older version of the software when the new is made available to consumers. The user may be faced with the option of buying the new version or risk losing any technical support for their current version of the software. In addition to the lack up technical support, some new versions of software programs are incompatible with some older computer hardware. The new software or software version may require a faster central processing unit (CPU) to run the software or may require more memory. These requirements would put a strain on the computer hardware resources. In this event, the user may not be able to use a new software program of their present computer.

There are many different types of computer users. Not all computer users need nor desire the absolute latest advancements in software. Some users prefer to use the existing software with which they are familiar. However, if a manufacturer decides to discontinue a product or version, the user may have no alternative but to acquire other software that can run on the user's computer.

In addition to the drawbacks from rapid software development, it is important to chronicle the evolution of the development of software for future generation.

A museum is a place that collects, maintains and displays items that can relate to and reveal the history of a particular subject. The items can be stored as a group in a collection or exhibit. Some exhibits enable a viewer to experience many features of the exhibit through animation and simulation capabilities. Sometimes an exhibit may include a room that will allow a person to view a historical event as if the person was actually at this event. Some simulation booths enable a person to feel what the actual people felt during that actual event. Computer software program have evolved over the years. However, there are not any known places where a person can get the experience of using a computer when there was no luxury of an interactive terminal interface. During the early years of FORTRAN programming punch cards were used to send information to a compute for processing. Today punch cards and keypunch machines are ancient memories to some people and a foreign concept to other people. In addition, there are limited opportunities to learn about some low-level languages such as microprocessor assembly languages without taking an engineering class where those languages are part of the curriculum.

A computer software storage and retrieval facility of legacy software serve a function for computer software that is similar to the function a museum serves for other subjects. This facility could be in the form of a method and system for storing, archiving and cataloging software programs that have been developed throughout history and accessing, retrieving and executing these stored software programs. The facility could provide countless opportunities to learn about the evolution of computer software from its beginning in the 1950's to its explosion today. This facility could house versions of software programs that were created as far back as the 1950's and could serve as an educational tool to help person understand more about the different types of software programs, how these programs interact with other programs and how these programs interact with and control computer hardware. There remains a need for a method and system to store, access and execute multiple versions of software programs that have been created throughout the development and expansion of computer technology and the computer industry.

### SUMMARY OF THE INVENTION

It is an objective of this invention to provide an electronic software facility that contains a chronology of the development of software over time.

It is a second objective of this invention to provide a repository for various versions of software programs that have been developed over years.

It is a third objective of this invention to provide a location where users can access various versions of the software program regardless of the development period of the software.

It is a fourth objective of the present invention to provide a method and system for archiving, cataloging and storing software programs that have been developed over many years.

It is a fifth objective of present invention to provide a method and system for accessing, retrieving and executing the stored software programs.

The present invention provides a method and system for creating a software storage, retrieval, and execution facility that charts the history and development of software programs. This facility could be located on a global computing network site that would contain collection of legacy software programs that span time from the introduction of computers and software beginning in the 1950's to the explosion of various software products being developed today. The intent is for each software versions to be stored in an executable form.

The key element for the system of the present invention is a computer programs database. This database would be a catalog of software applications and innovations, starting from the earliest FORTRAN Compiler, to such programs as DOS, OS2 and Xilog. These programs will include products in the computer network databases and all other disciplines in computer science. The invention also has a server that has the functions of interacting with a user and organizing and displaying database elements in response to a user's request.

### DESCRIPTION OF THE DRAWINGS

FIG. 1 is a diagram of a configuration of the system of the present invention.

FIG. 2 is a diagram of a database layout containing a software directory and versions of the software programs available for access and execution.

FIG. 3 is diagram of a software record in a database and a plurality of software programs linked together in the database to form particular software program collection.

FIG. 4 depicts data processing equipment a system that can be utilized to implement the present invention;

FIG. 5 is a diagram of a computer over which messages may be transmitted in the implementation of the method of the present invention;

FIG. 6 is a flow diagram of the general steps in the implementation of a method of the present invention.

FIG. 7 is a flow diagram of the steps involved in executing a software program stored in the database.

### DETAILED DESCRIPTION OF THE INVENTION

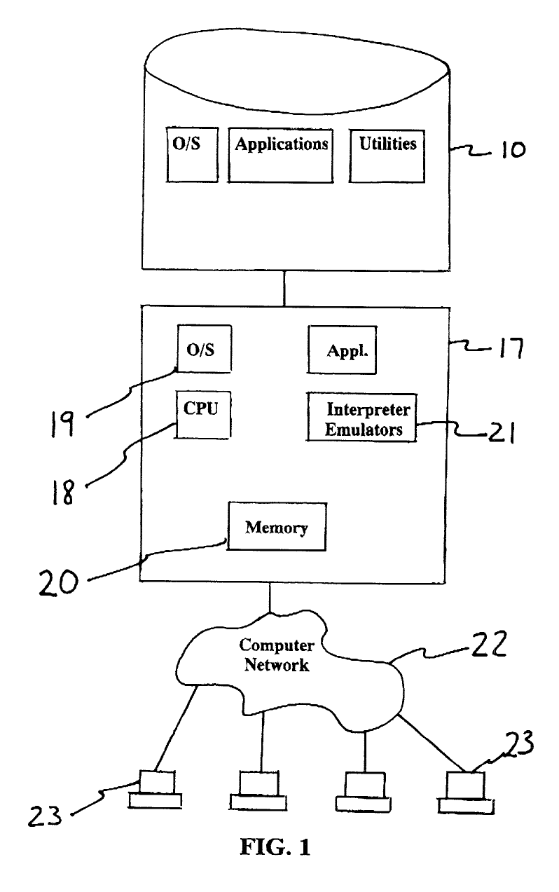

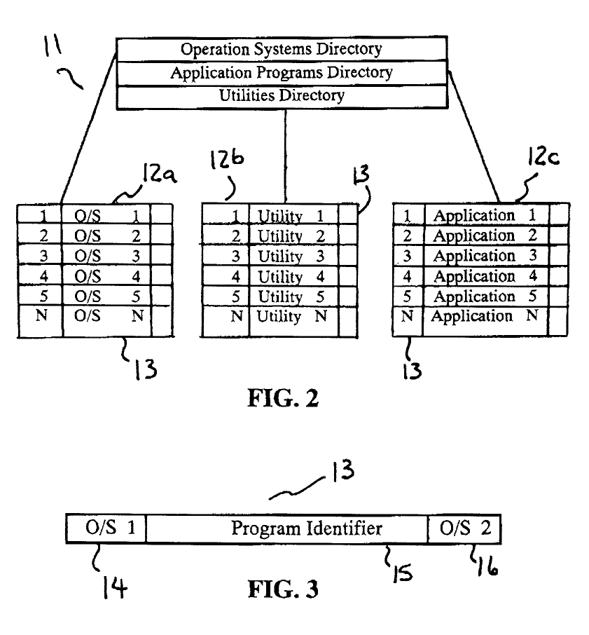

The present invention provides a method and system for creating a software facility that charts the history and development of software programs. FIG. 1 illustrates the components in the system for implementing the software facility. As shown, a software database 10 contains versions of software programs that have been developed throughout history from the beginning of the computer age. As shown in FIG. 2, these programs 11 are arranged by software type. Each software type has a directory to facilitate location and access of a particular software program. For example, there are three major categories of software programs. Therefore there would be a directory for each category which would include directories for operating system programs 12a, utility programs 12b and applications programs 12c. Each directory contains records 13 for each version of software in the directory. In addition, programs are created in various computer languages that enable the software program to communicate with the computer hardware that will execute the program. These languages include high-level source code languages such as FORTRAN, Pascal and COBOL (a business programming language). As previously discussed, other languages included assembly languages and machine languages. The arrangement of these programs can be of any currently available database scheme.

As shown in FIG. 3, a database record 13 contains an identifier for each software program stored in the database. As shown, the record contains an identifier field 14, a program description field 15. Some programs can contain a pointer field 16 that will enable that program to be linked to other programs in that directory and in other directories. In this record, the link field points to the second record in the operating systems directory O/S 2. These links will provide a means to connect together programs that relate to a common subject. In a museum, some exhibits contain a collection of items or works that are related to a central subject. These links enable that feature with software programs. A person may desire to view the history of a particular operating system such as UNIX. Over the years, the UNIX operating system has gone through many revisions and many versions to reach the most current version that is in use today. This database could contain many if not all of the versions of the UNIX operating system. Each version would be a different computer software program. Because these versions are related, the pointer fields would contain information that connects these programs. In one approach, each UNIX version could point to the next sequential version of the UNIX program in a chronological order from earliest to the most recent or vice versa.

FIG. 1 also shows that the software database could be contained in a software server device 17. This server contains the architecture that controls the maintenance, access, retrieval and execution of the software programs in the database. As shown there is a central processing unit 18 that executes software programs retrieved from the database. Operating systems programs 19 in the server control the access the retrieval of and access to the software programs contained in the database. A memory 20 stores these server system programs. Emulation and simulation programs 21 are located in the memory as well. The system programs 19 can call these programs during the execution of a retrieved software program when particular other software programs or hardware needed to execute the retrieved software program does not exist in the present system of the invention. These emulation and simulation can duplicate the functions of the hardware or software and provide for the execution of the retrieved software program. The software database 10 can also house these emulation and simulation programs.

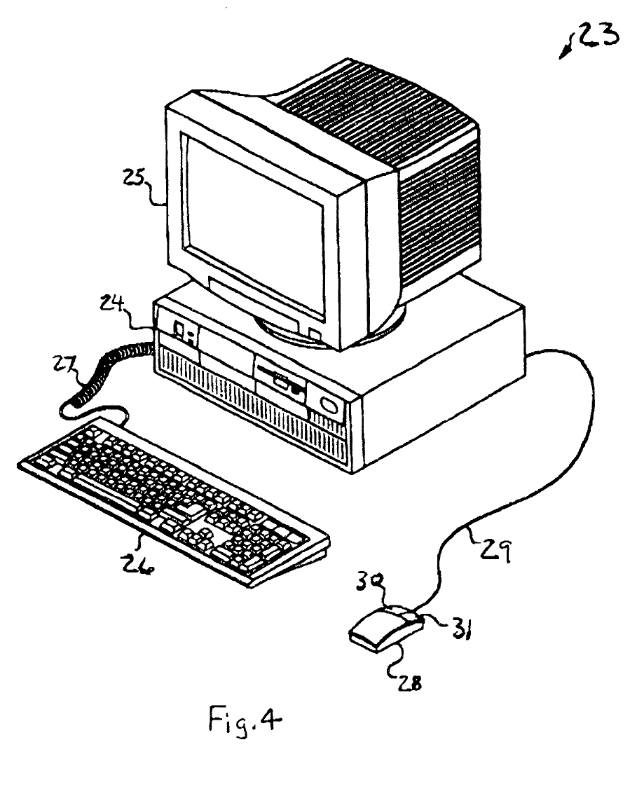

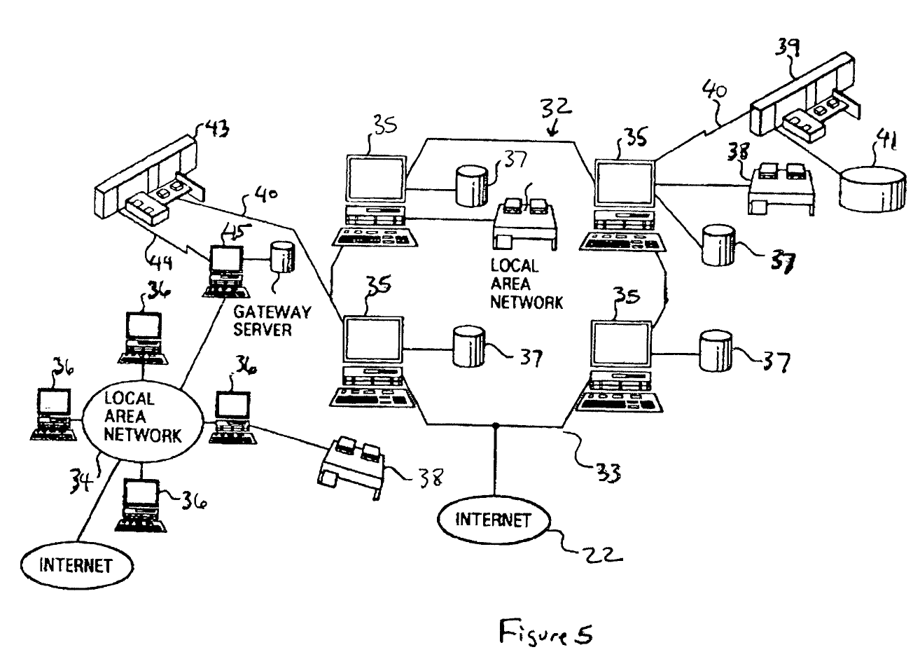

Users can access the facility server, via a global computer network 22, through interface devices 23. With reference now to FIG. 4, there is depicted a pictorial representation of an interface device such as a data processing system 23 which may be used in implementation of the present invention. As may be seen, data processing system 23 includes processor 24 that preferably includes a graphics processor, memory device and central processor (not shown). Coupled to processor 24 is video display 25 which may be implemented utilizing either a color or monochromatic monitor, in a manner well known in the art. Also coupled to processor 24 is keyboard 26. Keyboard 26 preferably comprises a standard computer keyboard, which is coupled to the processor by means of cable 27. Also coupled to processor 24 is a graphical pointing device, such as mouse 28. Mouse 28 is coupled to processor 24, in a manner well known in the art, via cable 29. As is shown, mouse 28 may include left button 30, and right button 31, each of which may be depressed, or “clicked”, to provide command and control signals to data processing system 23. While the disclosed embodiment of the present invention utilizes a mouse, those skilled in the art will appreciate that any graphical pointing device such as a light pen or touch sensitive screen may be utilized to implement the method and apparatus of the present invention. Upon reference to the foregoing, those skilled in the art will appreciate that data processing system 23 may be implemented utilizing a personal computer.

As mentioned, the method of the present invention may be implemented in a global computer network 22 environment such as the Internet. With reference now FIG. 5, there is depicted a pictorial representation of a distributed computer network environment 32 in which one may implement the method and system of the present invention. As may be seen, distributed data processing system 32 may include a plurality of networks, such as Local Area Networks (LAN) 33 and 34, each of which preferably includes a plurality of individual computers 35 and 36, respectively. Of course, those skilled in the art will appreciate that a plurality of Intelligent Work Stations (IWS) coupled to a host processor may be utilized for each such network. Any of the processing systems may also be connected to the Internet as shown. As is common in such data processing systems, each individual computer may be coupled to a storage device 37 and/or a printer/output device 38. One or more such storage devices 37 may be utilized, in accordance with the method of the present invention, to store the various data objects or documents which may be periodically accessed and processed by a user within distributed data processing system 23, in accordance with the method and system of the present invention. In a manner well known in the prior art, each such data processing procedure or document may be stored within a storage device 37 which is associated with a Resource Manager or Library Service, which is responsible for maintaining and updating all resource objects associated therewith.

Still referring to FIG. 5 it may be seen that distributed data processing system 23 may also include multiple mainframe computers, such as mainframe computer 39, which may be preferably coupled to Local Area Network (LAN) 33 by means of communications link 40. Mainframe computer 39 may also be coupled to a storage device 41 which may serve as remote storage for Local Area Network (LAN) 33. A second Local Area Network (LAN) 34 may be coupled to Local Area Network (LAN) 33 via communications controller 43 and communications link 44 to a gateway server 45. Gateway server 45 is preferably an individual computer or Intelligent Work Station (IWS), which serves to link Local Area Network (LAN) 34 to Local Area Network (LAN) 33. As discussed above with respect to Local Area Network (LAN) 34 and Local Area Network (LAN) 33, a plurality of data processing procedures or documents may be stored within storage device 41 and controlled by mainframe computer 39, as Resource Manager or Library Service for the data processing procedures and documents thus stored. Of course, those skilled in the art will appreciate that mainframe computer 39 may be located a great geographical distance from Local Area Network (LAN) 33 and similarly Local Area Network (LAN) 33 may be located a substantial distance from Local Area Network (LAN) 36.

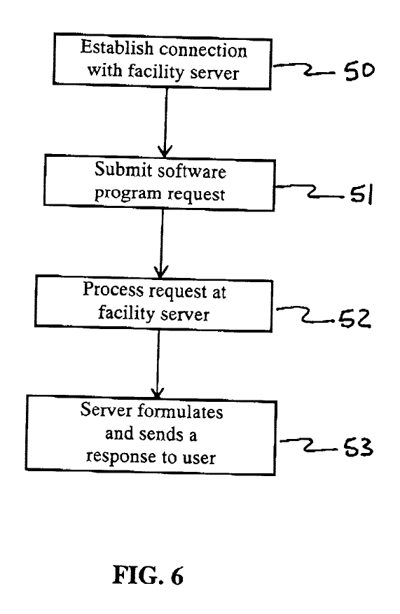

FIG. 6 illustrates the general steps in the implementation of the method of this invention. In the initial step 50, a user establishes communication with the facility server device 17 through an interface device such as a terminal 23. This communication is done over a global computing network 22. After establishing this connection, the user submits a request 51 to the facility server. This request will contain information about the particular software programs that are of interest to the user submitting the request. The facility server will process the request at the server 52. This location can be the location as the database, since the facility server 17 and the software database 10 can be located in the same machine. The request-processing step involves retrieving the software requested by the user, identifying the purpose for the request of the software and determining additional resources needed to enable the user to accomplish the identified purpose for the request. The software retrieval task involves locating the requested software in the database and retrieving that software to server. The purpose identification task concerns ascertaining from the request submission, the reason a user requests a particular software program. The user may want to only view and observe the software program to learn of its composition. The user may not want to execute every requested software program. The user may want to download the software to a remote machine for use at a later time. This situation may exist when the user has a machine that executes an older version of a program. This older version may no longer be supported by the manufacturer nor is this version available from the manufacturer. When a user desires to execute a program, there needs to be an appropriate computing environment to execute the program. For older versions of programs, this computing environment may not be the current state of computing hardware and software resources. Some software versions may run on processors that are also not currently in use or currently available. In these cases, simulator and emulator programs are used to replicate the functions of these devices and provide the computing environment that can execute the requested software program. Once the server has processed the request, in step 53, server formulates and sends a response to the user. This formulation could be creating a proper computing environment for the execution of a program in the server and retrieving software requested by the user.

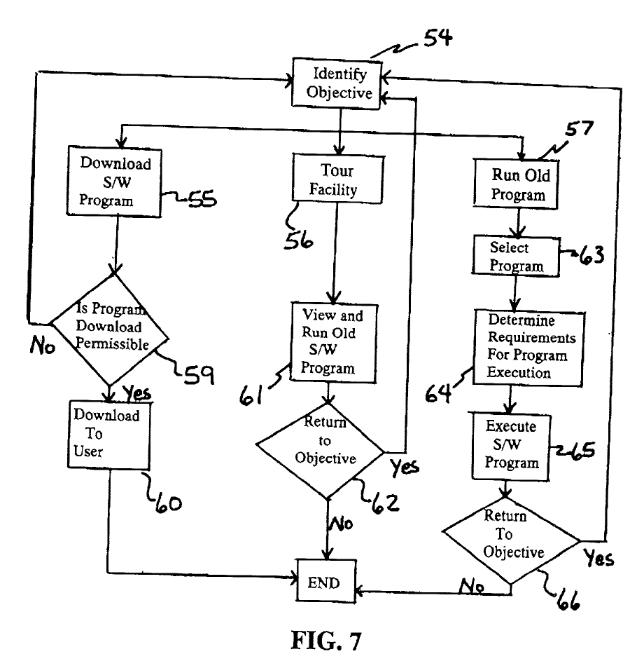

FIG. 7 shows more detailed steps in the implementation of the present invention. As shown in FIG. 6, in the initial step 50, a user establishes communication with the facility server device 17. After establishing this connection, the user submits a request 51 to the facility server. In this request, the user identifies the objective or purpose for the request 54. As shown, this identification could be interactive in that the facility server would supply the user with a set of options from which to choose. The options could be to download a particular version of a software program 55, to tour the facility for the purpose of observing the history of computer software 56 or to execute a version of a software program on the facility server 57.

In the download software option 55, the user will identify the machine on which this downloaded software would run. This download option is for users that already know the version of the software program. An example of this case is when the user has a machine that runs a particular software version that is no longer being distributed or supported by the manufacturer. After the user has identified the software version to download, the facility server makes a determination whether this download is permissible 59. This permission could be based on factors such as the identity of the user or on the type of machine that will execute the software program. The user may unknowingly attempt to download a software program to a machine that cannot execute the particular program. If the download is permissible, the facility server will download the particular version of the software to the user 60.

A second option 56 for a user is to simply tour the facility in a manner that many people tour other conventional museums. In this option a user could access a set of programs that are linked together in some chronological sequence to reveal the history of a particular software product 61. The user can also use this tour option to locate a particular version of a software program that the user wants to download or execute. If the user decides to execute a version of a program viewed during the tour, the user can return to the objective identification step 62. This option contains database-searching capabilities to enable the user to locate a particular version of a program. These programs searches would be based on description fields in the database record for the software programs. For example, if a user wanted to access Windows 3.0, the search routine would locate the Windows location in the operating systems directory 12a, the search would then locate the 3.0 version of the program. The search would then retrieve this version of the Windows operating system program. At this point the user can download and run the retrieved software or execute the software on the facility server. After the user has completed the software execution, the user can return to the objective identification step 54 or end the tour.

The third option 57 is to initially execute a software program version on the facility server. As with the download option 55, the user would identify/select the software program version to execute 63. The facility server will then create the computing environment necessary to execute the selected program 64. This step involves determining the resources needed to execute the program. In some instances, there is a need to simulate or emulate some of the hardware that executes the software. After creating the computing environment, the server would execute the software 65 and send any results to the user or display the results on the interface device 23. At the completion of the task, the user could then return 66 to the objective identification step 54 or end the operation.

It is important to note that while the present invention has been described in the context of a fully functioning data processing system, those skilled in the art will appreciate that the processes of the present invention are capable of being distributed in the form of instructions in a computer readable medium and a variety of other forms, regardless of the particular type of medium used to carry out the distribution. Examples of computer readable media include media such as EPROM, ROM, tape, paper, floppy disc, hard disk drive, RAM, and CD-ROMs and transmission-type of media, such as digital and analog communications links.

Having thus described the invention, what we claim as new and desire to secure by Letters Patent is set forth in the following claims.

We claim:

1. A system for maintaining, accessing and executing legacy computer software programs stored in a central location comprising:
a database for storing multiple software programs, some of said software programs being chronological versions of a particular software program developed and revised over a period of time, each said version being stored as a separate software program;
a computing device connected to said database capable of interacting with said database for the purpose of retrieving and executing software programs stored in said database;
a interface device connected to computing device for interacting with said computing device; and
a computing network for connecting said interface device and said computing device.

2. The system as described in claim 1 further comprising in said database, multiple versions of software programs, each version of a said software program being capable of executing in a particular computing environment.

3. The system as described in claim 2 wherein said software programs are stored in software directories according to the type of software program.

4. The system as described in claim 3 wherein said software directories include directories for operating system programs, application programs and utility programs.

5. The system as described in claim 2 further comprising links that connect set of previously identified software programs such that the connected software programs can be accessed sequentially.

6. The system as described in claim 1 wherein said interface device is a computer terminal.

7. The system as described in claim 1 wherein said computing device is a server.

8. The system as described in claim 7 wherein said server device comprises:
a central processing unit;
a memory;
emulator and simulator programs capable of creating particular computing environments; and
software retrieval programs for accessing and retrieving software stored in said database.

9. The system as described in claim 1 further comprising multiple interface devices capable of interacting with said server simultaneously.

10. A method for maintaining, accessing and executing legacy computer software programs stored in a central location comprising:
accessing a database that stores multiple types and multiple versions of software programs, some of said software versions being chronological sequences of a particular software program developed and revised over a period of time each program capable of executing in a computing environment;
submitting a software program request to a database controller;
retrieving the software program identified in the software program request;
determining whether to execute the retrieved software program; and
executing the retrieved software program.

11. The method as described in claim 10 further comprising and said retrieving step, the step of analyzing the different features and capabilities of the retrieved software program.

12. The method as described in claim 10 further comprising before said accessing step, the step of creating a database containing multiple types and multiple versions of software programs.

13. The method as described in claim 12 wherein said database creating step comprises:
creating a directory for each software program type;
placing each software program in the appropriate directory; and
assigning an identifier to each program.

14. The method as described in claim 13 further comprising the steps of:
creating specific collections of software programs by linking selected software programs together, said collection of programs becoming a software set.

15. The method as described in claim 10 further comprising after said accessing step, the steps of:
retrieving a software programs index, said index containing directories of each type software in the database and a list of each software program in each directory; and
identifying a specific software program in a software directory.

16. A method for accessing and executing software computer programs stored in a central database location, some of said software versions being chronological sequences of a particular software program developed and revised over a period of time, said method comprising the steps of:
accessing the database storing multiple types and versions of software programs;
retrieving from a controller connected to the database a software programs options list and a index of software types and software program versions;
submitting a request to the software controller containing a selected software programs option and an identified software program version;
retrieving from the database and identified software programs version; and
implementing the selected software option on the identified and retrieved software program.

17. The method as described in claim 16 wherein said implementation step comprises determining whether said selected program option is possible to implement and sending a decline message to the location to the submission when a selected option is not possible to implement on the identified and retrieved software program.

18. The method as described in claim 16 wherein said implementation step comprises creating a computing environment for executing the identified and selected software program.

19. The method as described in claim 18 wherein said computer environment creating step comprises determining the computer hardware and software necessary to implement the selected option on the retrieved software program.

20. The method as described in claim 19 wherein said implementation step occurs in the database controller.

21. The method as described in claim 19 wherein said implementation step occurs in a computing environment located at the software program request submission location.

22. A computer program product in a computer readable medium for accessing and executing software computer programs stored in a central database location comprising:
instructions for accessing the database storing multiple types and versions of software programs;
instructions for retrieving from a controller connected to the database a software programs options list and a index of software types and software program versions;
instructions for submitting a request to the software controller containing a selected software programs option and an identified software program version;
instructions for retrieving from the database and identified software programs version; and
instructions for implementing the selected software option on the identified and retrieved software program.

23. The computer program product as described in claim 22 wherein said implementation instruction further comprises:
instructions for determining whether said selected program option is possible to implement and;
instructions for sending a decline message to the location to the submission when a selected option is not possible to implement on the identified and retrieved software program.

24. The computer program product as described in claim 22 wherein said implementation instruction further comprises instructions for creating a computing environment for executing the identified and selected software program.

25. The computer program product as described in claim 24 wherein said computer environment creating instruction further comprises instructions for determining the computer hardware and software necessary to implement the selected option on the retrieved software program.

26. The computer program product as described in claim 25 wherein said implementation instructions occur in the database controller.

27. The computer program product as described in claim 25 wherein said implementation instructions occur in a computing environment located at the software program request submission location.

28. A computer connectable to a distributed computing environment and including a mechanism storing computer software programs, mechanisms for accessing and executing the stored computer software programs and mechanisms for transmitting and receiving messages over a computer network, said computer comprising:
a database of stored computer software programs, said programs comprising a collection of programs spanning a chronological range from the 1950's to the present, each said program capable of being executed in said computer;
a central processor;
a set of operating system programs to enable the execution of programs stored in said database; and
a set of emulation and simulation programs for use in the execution of programs stored in said database.
